(19) United States
(12) Patent Application Publication
(10) Pub. No.: US 2013/0332234 A1
(43) Pub. Date: Dec. 12, 2013

(54) Optimizing Market Research Using Indicia-Based Mobile Respondent Data

(71) Applicant: Palanivel Kuppusamy, (US)

(72) Inventor: Palanivel Kuppusamy, (US)

(73) Assignee: iPinion, Inc.

(21) Appl. No.: 13/492,213

(22) Filed: Jun. 8, 2012

(51) Int. Cl. G06Q 30/02

(52) U.S. Cl. 705/7.32

(57) ABSTRACT

Systems and methods described herein provide a mechanism for conducting meaningful market research on respondents using mobile devices. Data contained in code-based indicia relating to a mobile respondent is leveraged to initiate more effective market research applications such as surveys and the like. Using such information, a market research enterprise interested in focused market research may initiate market research specifically related to that mobile respondent, perhaps accounting for the mobile respondent's location, purchase history, financial means and associations, etc. The market research applications may be transmitted to mobile respondents by a number of different mechanisms such as push messages, text messages, SRS messages, emails, etc. Also, mobile respondents may download and install an application that allows them to quickly access the market research applications and transmit the market research data.

### CROSS-REFERENCE TO RELATED APPLICATIONS

This patent application is related to commonly assigned, co-pending U.S. patent application Ser. No. ______, filed Jun. 8, 2012 and entitled “OPTIMIZING MARKET RESEARCH BASED ON MOBILE RESPONDENT LOCATION” (Attorney Docket: ERWP.P0010US), commonly assigned, co-pending U.S. patent application Ser. No. ______, filed Jun. 8, 2012 and entitled “OPTIMIZING MARKET RESEARCH BASED ON MOBILE RESPONDENT BEHAVIOR” (Attorney Docket: ERWP.P0011US), and commonly assigned, co-pending U.S. patent application Ser. No. ______, filed Jun. 8, 2012 and entitled “OPTIMIZING MOBILE USER DATA STORAGE” (Attorney Docket: ERWP.P0012US), the disclosures of which are incorporated herein by reference in their entirety.

### TECHNICAL FIELD

This disclosure is generally directed to a system and method for optimizing mobile respondent market research. This disclosure is specifically directed to systems and methods for optimizing market research using indicia-based mobile respondent data.

### BACKGROUND

Market research is an organized effort to gather information about markets or customers. Market research can include social and opinion research performed to systematically gather and interpret information about individuals or organizations using statistical and analytical methods and techniques of the applied social sciences to gain insight or support decision making. Viewed as an important component of business strategy, market research can be a key factor to obtain advantage over competitors. Market research provides important information to identify and analyze market need, market size, and competition. The advent of mobile devices, such as smart phones, presents new opportunities for enlisting mobile device users as mobile respondents in performing market research.

Code-based indicia, such as a barcode, matrix code, QR CODE™, etc., is an optical, machine-readable representation of data. Originally, such indicia represented data by varying the widths and spacings of parallel lines. These types of indicia may be referred to as linear or one-dimensional (1D). Later, code-based indicia evolved into rectangles, dots, hexagons and other geometric patterns in two dimensions (2D). 2D systems use a variety of symbols, and are also known as matrix codes. Code-based indicia originally were scanned by special optical scanners called readers; later, scanners and interpretive software became available on devices including desktop printers and smart phones.

### SUMMARY

According to an embodiment, methods and systems are provided for conducting mobile respondent market research. Mobile respondent data is received from a mobile device associated with the mobile respondent. The mobile respondent data is, at some point, contained in code-based indicia. In response to receiving the mobile respondent data, a market research application is transmitted to the mobile respondent.

According to another embodiment, additional methods and systems are provided for conducting mobile respondent market research. A mobile device associate with a respondent scans code-based indicia. The code-based indicia contains data relating to the mobile respondent such as purchase items, store location, method of payment, respondent preferences, and the like. Data relating to the mobile respondent is transmitted. In response, the mobile device receives a market research application based on the transmitted data.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the present disclosure, reference is now made to the following descriptions taken in conjunction with the accompanying figures, in which:

FIG. 1 illustrates a network in which concepts described herein may be implemented;

FIG. 2 illustrates functional blocks executed to perform a method of mobile respondent market research according to the concepts described herein;

FIG. 3 illustrates functional blocks of components of an apparatus for mobile respondent market research according to the concepts described herein;

FIG. 4 illustrates system components for performing another method of mobile respondent market research according to the concepts described herein; and

FIG. 5 illustrates functional blocks of components of another apparatus for mobile respondent market research according to the concepts described herein.

### DETAILED DESCRIPTION

Systems and methods described herein provide a mechanism for conducting meaningful market research on respondents using mobile devices. Data contained in code-based indicia relating to a mobile respondent is leveraged to initiate more effective market research applications such as surveys and the like. Using such information, a market research enterprise interested in focused market research may initiate market research specifically related to that mobile respondent, perhaps accounting for the mobile respondent's location, purchase history, financial means and associations, etc. For example, a respondent may execute a purchase transaction at Wal-Mart, notice a QR code printed on the receipt and an indication that, by submitting the QR code to the market research enterprise, the mobile respondent will be eligible for a reward. The mobile respondent may scan the QR code, which may comprise information relating to items purchased, store location, means of payment, and the like, and transmit data contained therein to a middleware system or directly to the market research enterprise. From such information, the mobile respondent may be questioned about her shopping experience; while a respondent determined to be at a car dealership may be questioned about her experience with sales personnel. The market research applications may be transmitted to mobile respondents by a number of different mechanisms such as push messages, text messages, SRS messages, emails, etc. Also, mobile respondents may download and install an application that allows them to quickly access the market research applications and transmit the market research data.

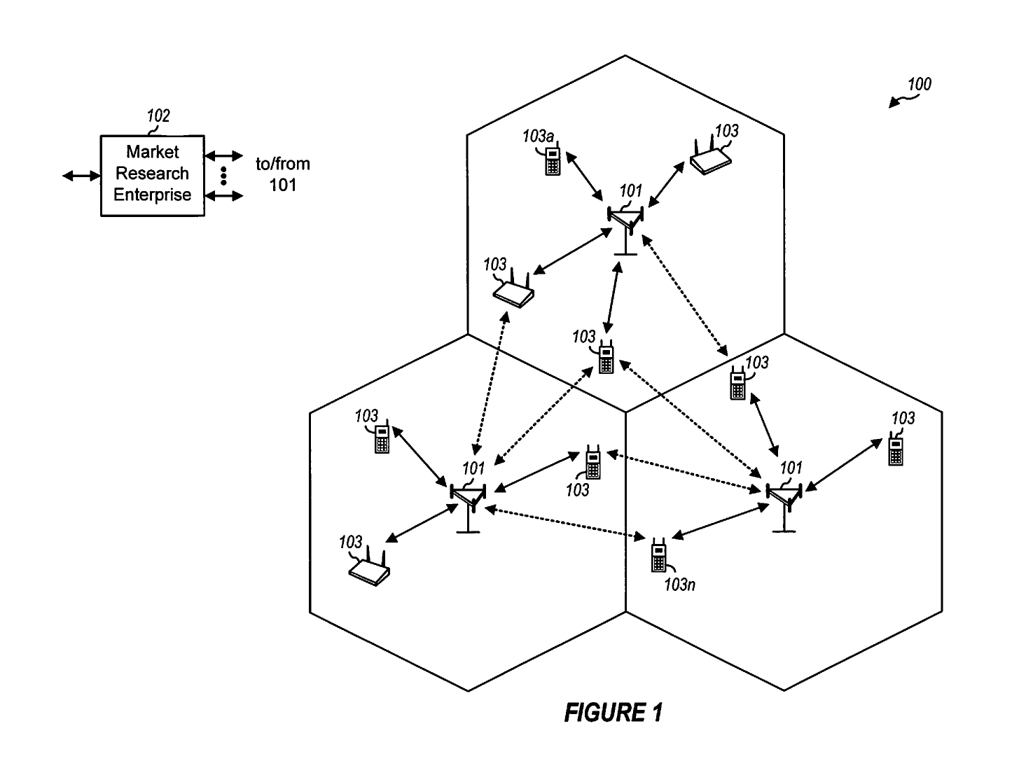

FIG. 1 illustrates network 100 in which concepts described herein may be implemented. Middleware system 101 is in communication with market research enterprise 102 and a plurality of mobile devices 103a-103n. Middleware system 101 is shown as a distributed network, having a plurality of base stations/eNodeBs that coordinate with one another to perform operations described herein. However, it will be understood by those of skill in the art that all or portions of middleware system 101 will comprise a centralized location (perhaps one of a base station/eNodeB, a controller, or enterprise) to enable the operations. As will be further described, middleware system 101 communicates with market research enterprise 102 and mobile devices 103 to enable market research for mobile respondents who come within a proximity of one or more locations of interest. According to one embodiment, middleware 101 and/or market research enterprise 102 may be a market research enterprise that focuses on conducting market research on respondents.

Network 100 may be implemented using a number of wireless communication methods between middleware system 101 and mobile devices 103 and wireless and/or wireline communication methods between middleware system 101 and market research enterprise 102. Such wireless methods include CDMA, TDMA, FDMA, OFDMA, SC-FDMA. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies described above, as well as other wireless networks and radio access technologies. According to a preferred embodiment, middleware system 101 communicates with market research enterprise 102 and/or mobile devices 103 using LTE or LTE-A wireless communication methods.

While middleware system 101 is illustrated as separate from market research enterprise 102, it should be appreciated that, in some embodiments, middleware system 101 and market research enterprise 102 may be collocated and operate under the direction of shared hardware and software.

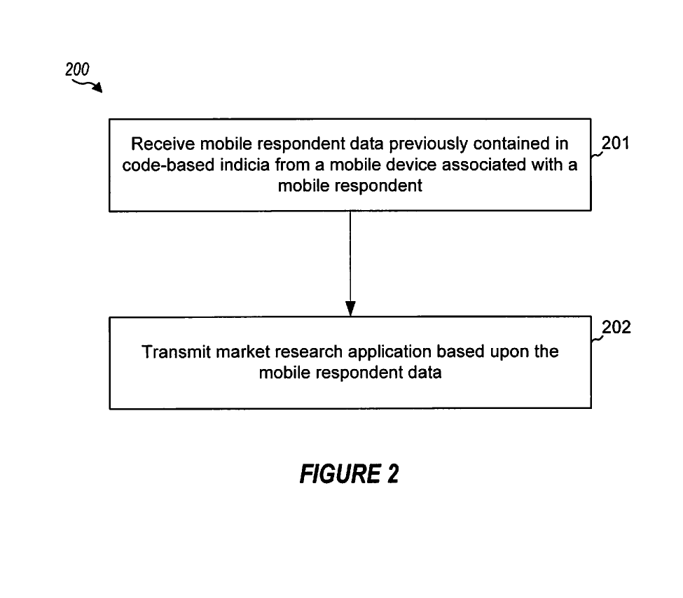

FIG. 2 illustrates functional blocks executed to perform a method of mobile respondent market research according to the concepts described herein. Specifically, FIG. 2 illustrates functional blocks executed by a middleware system such as middleware system 101 illustrated at FIG. 1.

At block 201 mobile respondent data previously contained in code-based indicia is received from a mobile device associated with a mobile respondent. A mobile respondent may employ mobile device 103, such as a smart phone or tablet, to scan the indicia and generate data from that contained in the indicia for transmission to middleware system 101 or market research enterprise 102. One skilled in the art will recognize that scanning applications are readily available for use by smart phones to scan matrix indicia, such as QR CODE™ indicia. Accordingly, in a preferred embodiment, the indicia corresponds to matrix indicia, such as QR CODE™ indicia. However, it should be readily understood that other types of indicia may be generated in other embodiments in accordance with the present disclosure. Code-based indicia may be contained in or printed on a receipt and, as such, may provide information relating to the mobile respondent. This information may relate to a broader category of mobile respondent data including profile data, behavioral data, and location data. Within such indicia printed on a receipt, information such as store location, method of payment, and items purchase may be represented. According to other embodiments, the code-based indicia may be printed or formed on other mediums, such as a product or package, sales or marketing literature, a brochure, a magazine etc. In such cases, additional information, such as product-specific and/or store-specific information, may be embedded in the indicia and further used to gain insight on transmitting a unique market research application to the mobile respondent. As such, insightful information relating to the mobile respondent's location, experience, preferences, financial associations, and the like can be understood by a market research enterprise receiving such information.

As an alternative to automatically transmitting data contained in the indicia, or supplemental thereto, mobile device 103 may employ a user interface to receive user input specifying a destination, such as an email address or a telephone number, and transmit data contained in the indicia to the mobile respondent's preferred destination. It is also envisioned that a device receiving the indicia in this manner may be configured to extract the mobile respondent data and generate the mobile respondent data to a user of middleware system 101.

Mobile respondent data may be location data, behavioral data, profile data, etc. That is, in addition to the mobile respondent data contained in the code-based indicia, mobile device 103 may also transmit behavioral data such as mobile respondent internet history, applications downloaded and utilized the most, text message use vs. phone use, etc. A mechanism for transmitting such data from a mobile device to another system is described in commonly assigned, co-pending U.S. patent application Ser. No. ______, filed Jun. 8, 2012 and entitled “OPTIMIZING MARKET RESEARCH BASED ON MOBILE RESPONDENT BEHAVIOR” (Attorney Docket: ERWP.P0011US), the disclosure of which is herein incorporated by reference. Other additional data may include mobile respondent profile data. Such data may be used to create an initial profile such as demographic data, employment and lifestyle data, preference data, respondent preferences, hobbies, general interests, etc.

At block 202 a market research application based upon the mobile respondent data is transmitted. The market research application may be transmitted to mobile respondents by a number of different mechanisms such as push messages, text messages, SRS messages, emails, etc. Also, mobile respondents may download and install an application that allows them to quickly access the market research application and transmit the market research data.

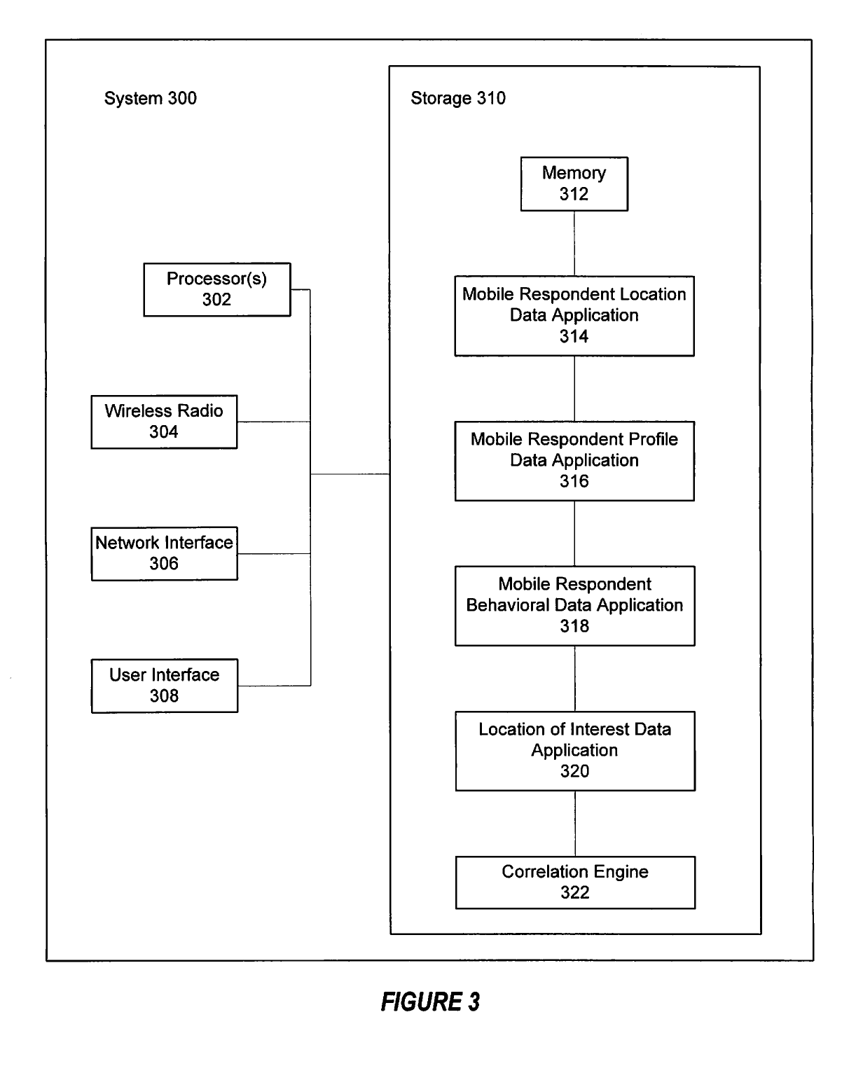

FIG. 3 illustrates a block diagram of components of an apparatus that enables mobile respondent market research according to the concepts described herein. Specifically, FIG. 3 illustrates components of a middleware system such as middleware system 101 illustrated at FIG. 1. Each component may comprise hardware, software, firmware, program code, or other logic (for example, ASIC, FPGA, etc.), as may be operable to provide the functions described herein.

The functionality and operations of storage system 300 are controlled and executed through processor(s) 302. Processor(s) 302 may include one or more core processors, central processing units (CPUs), graphical processing units (GPUs), math co-processors, and the like. Processor(s) 302 execute program logic, whether implemented through software stored in a memory 312 or in firmware in which logic is integrated directly into integrated circuit components. Storage system 300 may communicate wirelessly with multiple client systems and mobile devices through various radios, such as wireless radio 304, such as one or more of wireless wide area network (WWAN) radios and wireless local area network (WLAN) radios. If a WWAN radio is included as one of the radios in wireless radio 304, communication would generally be allowed over a long range wireless communication network such as an LTE network. Storage system 300 may also provide communication and network access through a wired connection with network interface 306. The wired connection may connect to the public-switched telephone network (PSTN), or other communication network, in order to connect to the Internet or other accessible communication network.

System 300 comprises storage 310, which includes memory 312, mobile respondent location data 314, mobile respondent profile data application 316, mobile respondent behavioral data application 318, location of interest data application 320, and correlation engine 322. Under control of processor(s) 302, program logic stored on memory 312, including mobile respondent location data application 314, mobile respondent profile data application 316, mobile respondent behavioral data application 318, location of interest data application 320, correlation engine 322, and other applications provides functionality of storage system 300, including communications, storage, computation, and filtering, analysis, and correlation of location data, profile data, behavioral data, and location of interest data. Such operating applications may be displayed visually to the user via user interface 308. User interface 308 includes various hardware and software applications that control the rendering of visual data onto the display screen of computers of storage system 300 (not shown). User interface 308, under control of the processor(s) 302, controls and operates all forms of interfaces between the user and storage system 300. As such, when storage system 300 is implemented using a touch screen display, user interface 308 may read the user's input and finger motions on the touch screen and translate those movements or gestures into electronic interface navigational commands and data entry. Various embodiments of user interface 308 also will receive the rendered visual data through processing, controlled by processor(s) 302, and display that visual data on the display. During input to a touch screen device, the user interface 308 may be receiving and analyzing input data from a user's finger movements and gestures on the display screen.

Mobile respondent location data application 314, mobile respondent profile data application 316, mobile respondent behavioral data application 318, location of interest data application 320, and correlation engine 322 may be interfaced with one another to configure the processor(s) 302 to receive various types of data from mobile respondents for various operations described with reference to FIG. 2. Each application may extract corresponding data previously contained in code-based indicia and transmitted to middleware system 300. That is, application 314 operates to extract mobile respondent location data, application 316 operates to extract mobile respondent profile data, and so on. Correlation engine 322 may be interfaced with mobile respondent location data application 314, mobile respondent profile data application 316, mobile respondent behavioral data application 318, and location of interest data application 320 to compile, analyze, correlate and/or filter the data as needed. Correlation engine 322 may further execute instructions to determine what market research application should be transmitted to a mobile respondent based on data received therefrom. Correlation engine 322 may further operate to configure processor(s) 302 to select such application to execute those operations.

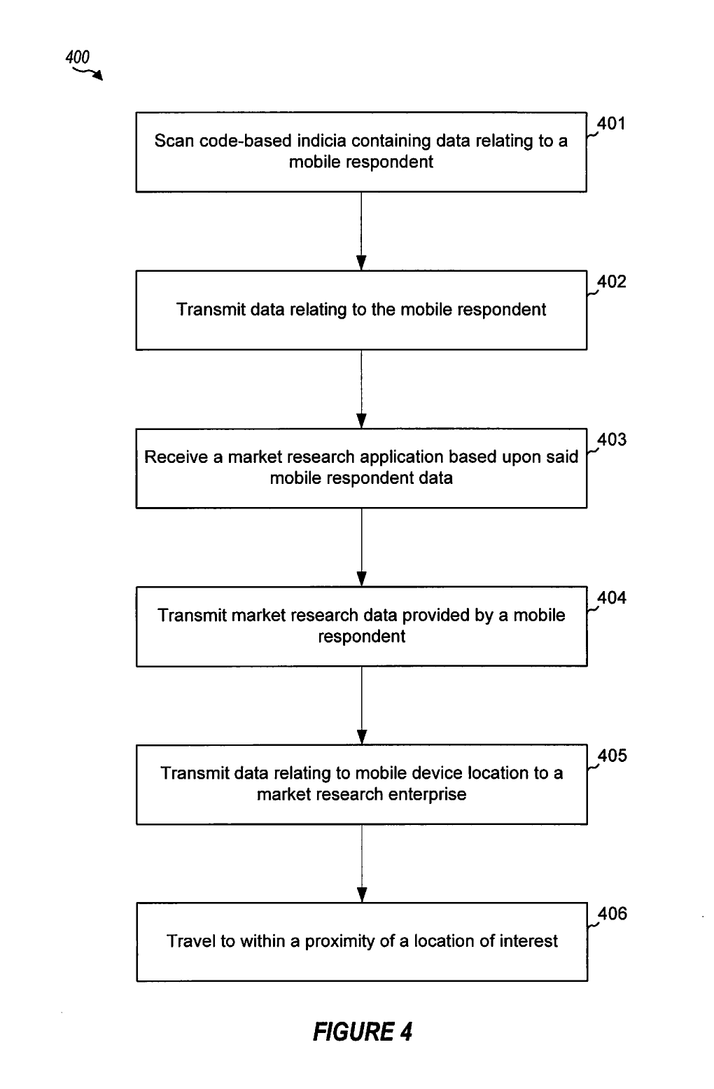

FIG. 4 illustrates functional blocks executed to perform a method of mobile respondent market research according to the concepts described herein. Specifically, FIG. 4 illustrates functional blocks executed by a mobile devices such as one or more of mobile devices 103 illustrated at FIG. 1. The functional blocks may be executed at the direction of one or more of hardware, software, and inputs received from a respondent.

At block 401a mobile device scans code-based indicia containing data relating to a mobile respondent. The mobile device may contain an application causing its processor to operate a camera or scanner to perform a scan of indicia, extract mobile respondent data from results of the scan, and transmit that data to a middleware system and/or a market research enterprise. According to an embodiment, scanning the code-based indicia requires initiation by a mobile user to launch a market search application, such as a web application survey and the like. It should be appreciated this functionality may, in some embodiments, by implemented independently than other functions such as, e.g., the transmission of location data, behavioral data, etc., as described herein.

At block 402 the mobile device transmits data relating to the mobile respondent. This data is extracted from the scanned code-based indicia. Similar to the discussion relating to FIG. 2, the data may include various attributes that reflect a respondent's activities, preferences, and/or experiences. The behavioral data may include location, purchased items, method of payment, text message activity, cellular phone activity, web browsing and email activity, and the identity of applications installed on a respondent's mobile device. The data may also comprise comparison data such as between the amount of text message activity and cellular phone activity and the frequency at which certain applications are used by the respondent. Further, the behavioral data may have a component relating to the respondent's previous locations.

Further, the data may be transmitted according to different mechanisms such as according to determined time intervals or upon the occurrence of an event or condition (e.g., automatically upon scanning the code-based indicia, or in response to user instructions). Also, the data may be collected at the mobile device in a number of ways. According to one embodiment, the functionalities described herein are provided by a market research application installed on the respondent's mobile device. Such an application may collect behavioral data on a continuous or incremental basis, running as a background application on the respondent's mobile device.

At block 403 the mobile device receives a market research application based upon said mobile respondent data. The mobile research application may comprise surveys with different objectives and may be transmitted according to different formats such as push messages, text messages, SRS messages, emails, and the like to a mobile respondent's mobile device 103.

At block 404 market research data provided by a mobile respondent is transmitted by the mobile device. The mobile respondent provides the market research data by, e.g., completing the previously-received market research application. As such, the transmitted data may comprise a completed survey, a partially-completed survey, a decline to participate in the survey, a request for additional data or instructions, an error message signifying an unsuccessful survey process (perhaps due to low signal strength of mobile device 103), etc.

At block 405 the mobile device transmits data relating to its location to a market research enterprise. In that case, the market research application received by the mobile device may be further based upon the transmitted location data. Similar to the mobile device's transmission of behavioral data, the location data may be transmitted according to different mechanisms such as according to determined time intervals or upon the occurrence of an event or condition. Also, the location data may be collected at the mobile device in a number of ways. According to one embodiment, the functionalities described herein are provided by a market research application installed on the respondent's mobile device. Such an application may collect location data on a continuous or incremental basis, running as a background application on the respondent's mobile device. Also, the location data may be transmitted in various formats such as GPS-based coordinate, latitude and longitude values, and the like. According to another embodiment, network signals such as beacon signals, signals generated during handoff, and requests for service may serve as signal sufficient for a network to determine the location of the mobile device. In that case the mobile device transmits signals sufficient for the network to determine its location (using, for example, base station/eNodeB triangulation, network statistics data, etc.).

At block 406, according to an additional or alternative embodiment, the mobile device comes within a proximity of a location of interest. In that case, the market research application received by the mobile device may be further based upon the mobile device coming within the proximity of the location of interest. In this way, behavioral data and location data associated with a mobile respondent may be correlated to provide a highly unique market research application to that respondent. The determination may be made by looking back in time where one or more sets of mobile respondent location data is examined over a preceding time interval. Also, the determination may be made during or close to real-time. Further, the determination may be predictive where, for example, the market research enterprise predicts whether a mobile respondent will move in proximity to a location of interest at a future time.

A location of interest may be defined differently depending on system parameters, client preferences, and the like. According to one example, the location of interest may be defined in terms of “raw” data where the location of interest is defined in terms of coordinates, GPS references, latitude and longitude, and the like. According to another example, the location of interest may defined in terms of characteristics of that location. That is, a location of interest may be defined by a particular business or enterprise at the location. The locations of interest may be stored in terms of one or multiple instances, enabling the market research enterprise to determine when a mobile respondent comes in proximity of, for example, a Wal-Mart, or a number of different coordinates without regard to what, if any, business may be located thereat.

The determination of what proximity causes transmission of the mobile research application may be determined by the market research enterprise, and may vary according to different mechanisms, a given market research application, system limitations, and the like. For example, some market research applications may be initiated where a mobile respondent has come within a mile of a location of interest, while other applications may be initiated where the mobile respondent has come within 20 feet of a location of interest.

It should be appreciated that the functions performed with reference to FIG. 4 may be iterative where, e.g., an updated or revised market research application is transmitted to a mobile device based on updated information received from the mobile device. The updated information may comprise new behavioral data, new market research data, and new location data. Through this iterative process, a market research enterprise can incrementally refine its market research applications to provide more relevant applications to respondents.

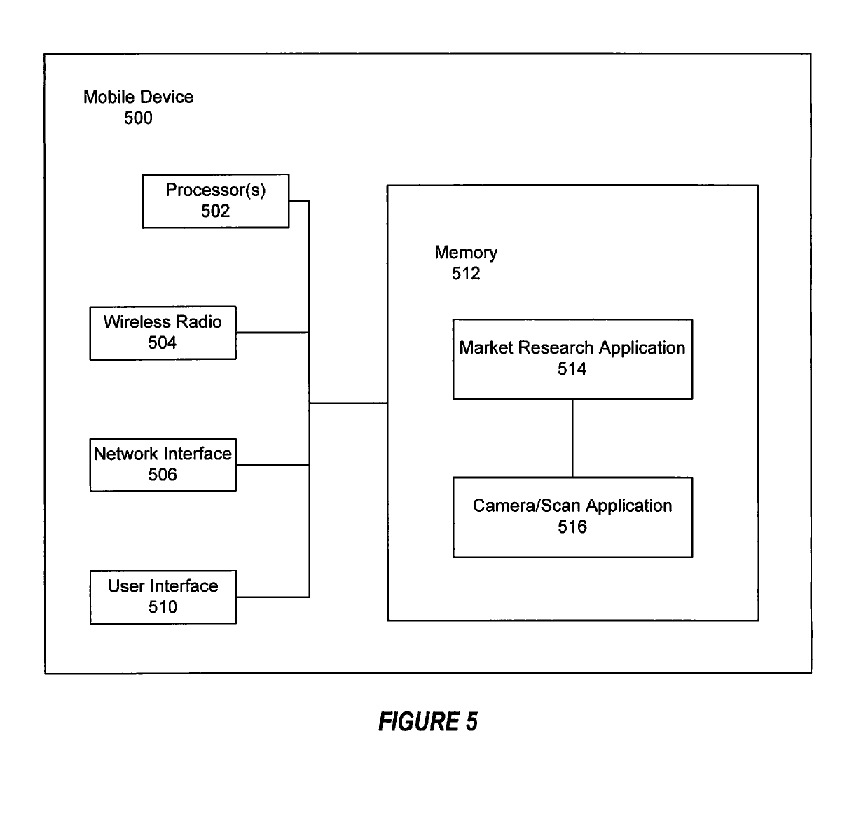

FIG. 5 illustrates a block diagram of components of an apparatus that enables mobile respondent market research according to the concepts described herein. Specifically, FIG. 5 illustrates components of a mobile device such as one or more of mobile devices 103 illustrated at FIG. 1. Each component may comprise hardware, software, firmware, program code, or other logic (for example, ASIC, FPGA, etc.), as may be operable upon or executed to provide the functions described herein. As such, mobile device 500 includes various components common to many typical smart phones, tablet computers, notebook and netbook computers, computers, and the like. Devices, such as mobile device 500 include the processing power, memory, and programming to perform complex tasks, run complex programs, and interact substantially with a user.

The functionality and operations of mobile device 500 are controlled and executed through processor(s) 502. Processor(s) 502 may include one or more core processors, central processing units (CPUs), graphical processing units (CPUs), math co-processors, and the like. Processor(s) 502 execute program logic, whether implemented through software stored in a memory 512 or in firmware in which logic is integrated directly into integrated circuit components. Mobile device 500 may communicate wirelessly through various radios, such as wireless radio 504, such as one or more of wireless wide area network (WWAN) radios and wireless local area network (WLAN) radios, such as WIFI™ radios, BLUETOOTH® radios, and the like. If a WWAN radio is included as one of the radios in wireless radio 504, communication would generally be allowed to communicate over a long range wireless communication network such as 3G, 4G, LTE, and the like. Various WLAN radios, such as WIFI™ radios, BLUETOOTH® radios, and the like, would allow communication over a shorter range. Mobile device 500 may also provide communication and network access through a wired connection with network interface 506. The wired connection may connect to the public-switched telephone network (PSTN), or other communication network, in order to connect to the Internet or other accessible communication network.

Under control of processor(s) 502, program logic stored on memory 512, including market research application 514, camera/scan application 516, and other applications provide functionality of mobile device 500, including communications, Internet access, and execution of various programs for productivity, entertainment, and the like. Applications stored in memory 512 may, when executed by processor(s) 502, operate calendar programs, game programs, list programs, social media programs, web browsers, and the like. Such operating applications are displayed visually to the user via user interface 510. The user interface 510 includes various hardware and software applications that control the rendering of visual data onto the display screen of the mobile device (not shown). The user interface 510, under control of the processor(s) 502, controls and operates all forms of interfaces between the user and mobile device 500. As such, when mobile device 500 is implemented using a touch screen display, user interface 510 may read the user's input and finger motions on the touch screen and translates those movements or gestures into electronic interface navigational commands and data entry. Various aspects of user interface 510 also will receive the rendered visual data through processing, controlled by processor(s) 502, and display that visual data on the display. During input to a touch screen device, the user interface 510 may be receiving and analyzing input data from a user's finger movements and gestures on the display screen. It may also be receiving data from the processor(s) 502 in the form of processed visual or sound data to be output by display to the user, some of which may be to reflect movement of screen objects in response to the user's finger movements.

Market research application 514 may configure the processor(s) 502 to extract a received market research application, whether the market research application is launched within the application itself or launched by a respondent following a link found on a webpage, text message, or email. In operation, the processor(s) 502 may launch market research application 514 in response to the respondent selection to initiate the market research application and provide market research data in response thereto. This may be performed by calling camera/scan application 516 to initially scan code-based indicia containing data relating to a mobile respondent.

The processor(s) 502 may employ the user interface 510 to receive respondent input to market data and establish a connection with other systems to transmit that data. Market research application 514 may be further configured to transmit mobile device location data, behavioral data, and/or profile data at predetermined intervals, which may dynamically change according to concepts described herein. Further, market research application 514 may extract respondent data from mobile device 500 according to described concepts. Camera/scan application 516, which may reside in market research application 514, configures the processor(s) 502 to establish a connection for mobile device 500 to transmit market research data, location data, and behavioral data in a manner that will be readily appreciated by one skilled in the art.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for conducting market research, said method comprising:
receiving mobile respondent data, said mobile respondent data comprising data extracted from code-based indicia at said mobile respondent;
correlating said data extracted from code-based indicia and other data generated at said mobile respondent; and
transmitting a market research application to said mobile respondent based upon said correlated data extracted from code-based indicia and other data.

2. The method of claim 1 further comprising:
receiving, from said mobile device, market research data provided by said mobile respondent in response to said market research application.

3. The method of claim 2 further comprising:
transmitting data relating to said received market research data to a market research enterprise.

4. The method of claim 1 further comprising:
receiving location data from said mobile device; and
wherein transmitting said market research application is further in response to receiving said location data.

5. The method of claim 1 wherein said data relating to a mobile respondent comprises:
identity of items purchased in a purchase transaction.

6. The method of claim 1 wherein said data relating to a mobile respondent comprises:
method of payment in a purchase transaction.

7. The method of claim 1 wherein said data relating to a mobile respondent comprises:
store location at which a purchase transaction was included.

8. A system configured for market research, said system comprising:
at least one processor; and
a memory coupled to the at least one processor, wherein the at least one processor is configured to:
receive mobile respondent data, said mobile respondent data comprising data extracted from code-based indicia at said mobile respondent;
correlate said data extracted from code-based indicia and other data generated at said mobile respondent; and
transmit a market research application to said mobile respondent based upon said correlated data extracted from code-based indicia and other data.

9. The system of claim 8 wherein said processor is further configured to:
receive, from said mobile device, market research data provided by said mobile respondent in response to said market research application.

10. The system of claim 9 wherein said processor is further configured to:
transmit data relating to said received market research data to a market research enterprise.

11. The system of claim 8 wherein said processor is further configured to:
receive location data from said mobile device; and
transmit said market research application further in response to receiving said location data.

12. The system of claim 8 wherein said processor is further configured to:
transmit identity of items purchased in a purchase transaction.

13. The system of claim 8 wherein said processor is further configured to:
transmit method of payment in a purchase transaction.

14. The system of claim 8 wherein said processor is further configured to:
transmit store location at which a purchase transaction was included.

15. A method for conducting market research, said method comprising:
scanning, at a mobile device, code-based indicia containing data relating to a mobile respondent;
transmitting, from said mobile device, said scanned data relating to said mobile respondent and other data generated by said mobile respondent; and
receiving, at said mobile device, a market research application generated by correlating said scanned data and said other data generated by said mobile respondent.

16. The method of claim 15 further comprising:
transmitting, from said mobile device, market research data provided by said mobile respondent in response to said market research application.

17. The method of claim 15 further comprising:
transmitting location data from said mobile device; and
wherein receiving said market research application is further in response to transmitting said location data.

18. The method of claim 15 wherein said data relating to a mobile respondent comprises:
identity of items purchased in a purchase transaction.

19. The method of claim 15 wherein said data relating to a mobile respondent comprises:
method of payment in a purchase transaction.

20. The method of claim 15 wherein said data relating to a mobile respondent comprises:
store location at which a purchase transaction was included.

21. The method of claim 15 wherein said data relating to a mobile respondent comprises:
mobile respondent internet activity.

22. The method of claim 15 wherein said data relating to a mobile respondent comprises:
mobile respondent text message activity.

23. The method of claim 15 wherein said data relating to a mobile respondent comprises:
mobile respondent cellular phone activity.

24. The method of claim 15 wherein said data relating to a mobile respondent comprises:
a comparison between mobile respondent text message activity and call activity.

25. A system configured for market research, said system comprising:
at least one processor; and
a memory coupled to the at least one processor, wherein the at least one processor is configured to:
scan, at a mobile device, code-based indicia containing data relating to a mobile respondent;
transmit, from said mobile device, data relating to said mobile respondent and other data generated by said mobile respondent; and
receive, at said mobile device, a market research application generated by correlating said scanned data and said other data generated by said mobile respondent.

26. The system of claim 25 wherein said processor is further configured to:
transmit, from said mobile device, market research data provided by said mobile respondent in response to said market research application.

27. The system of claim 25 wherein said processor is further configured to:
transmit location data from said mobile device; and
receive said market research application further in response to transmitting said location data.

28. The system of claim 25 wherein said processor is further configured to:
transmit identity of items purchased in a purchase transaction.

29. The system of claim 25 wherein said processor is further configured to:
transmit method of payment in a purchase transaction.

30. The system of claim 25 wherein said processor is further configured to:
transmit store location at which a purchase transaction was included.

31. The system of claim 25 wherein said processor is further configured to:
transmit mobile respondent internet activity.

32. The system of claim 25 wherein said processor is further configured to:
transmit mobile respondent text message activity.

33. The system of claim 25 wherein said processor is further configured to:
transmit mobile respondent cellular phone activity.

34. The system of claim 25 wherein said processor is further configured to:
transmit a comparison between mobile respondent text message activity and phone call activity.
